(19) United States
(12) Patent Application Publication
(10) Pub. No.: US 2010/0247260 A1
(43) Pub. Date: Sep. 30, 2010

(54) MACHINE TOOL FOR THE PRODUCTION OF TEETH ON WORKPIECES AND METHOD FOR THE PRODUCTION OF TEETH ON A WORKPIECE BY MEANS OF A MACHINE TOOL

(75) Inventors: Moshe Israel Meidar, New York, NY (US); Wolfgang Horn, Goeppingen (DE); Markus Stanik, Albershausen (DE); Holger Kolb, Ludwigsburg (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: MAG Powertrain GmbH

(21) Appl. No.: 12/717,571

(22) Filed: Mar. 4, 2010

Related U.S. Application Data
(63) Continuation of application No. PCT/EP2008/060952, filed on Aug. 21, 2008.

(30) Foreign Application Priority Data
Sep. 7, 2007 (DE) 10 2007 044 283.3

(51) Int. Cl. B23F 1/00

(52) U.S. Cl. 409/62

(57) ABSTRACT

A machine tool for the production of teeth on workpieces is provided, comprising a workpiece holding device, a cold rolling device for the production of rough teeth on at least one workpiece held by the workpiece holding device by way of cold rolling and a cutting machining device for the fine cutting machining of the rough teeth of the at least one workpiece which is held on the workpiece holding device.

### CROSS REFERENCE TO RELATED APPLICATIONS

This application is a continuation of international application number PCT/EP2008/060952 filed on Aug. 21, 2008, which claims priority from German application number 10 2007 044 283.3 filed Sep. 7, 2007, which are incorporated herein by reference in their entirety and for all purposes.

### BACKGROUND OF THE INVENTION

The invention relates to a machine tool for the production of teeth on workpieces, comprising a workpiece holding device.

The invention relates, in addition, to a method for the production of teeth on a workpiece by means of a machine tool, with which a workpiece is clamped on a workpiece holder.

WO 01/94048 A1 discloses a cold rolling machine with two profiled rolling racks which are driven in opposite directions, are each mounted on a guide via a slide and are in engagement with a tool mounted for rotation between the rolling racks. A feeding device is provided with at least one feeding drive, via which the rolling racks can be displaced in the direction of engagement during the rolling process.

WO 2006/045566 A1 discloses a cold rolling machine which comprises a first movable rolling rack holder and a second movable rolling rack holder. A first rolling rack and a second rolling rack of a pair of rolling racks are movable in opposite directions to one another in a direction of guidance via the rolling rack holder and the rolling racks are displaceable in a direction of displacement transverse to the direction of guidance during a rolling process. A workpiece holding device with a plurality of workpiece holders is provided.

DE 26 04 281 A1 discloses a machine for shaving and/or profile rolling the teeth of toothed wheels with a rotating, toothed tool for the finish machining of the teeth, a part for supporting the toothed wheel along its axis of rotation, a drive motor for the rotational movement of the tool and a device for bringing about a common relative movement of the axes of rotation of the tool and the wheel to be machined. At least two orthogonal movements can be generated via the device by means of motors, each of which, like the drive motor for the rotational movement of the tool, has is own electronic regulator circuit connected to a set value generator.

DE 196 50 350 C2 discloses a tool for the pressure rolling of a workpiece with teeth which has a profiling contour with tool teeth, the height of which extends from a tool base circle as far as a tool top circle, between which tool tooth flanks are arranged which are designed as a negative in relation to the force transferring tooth flank areas of the workpiece. A top-side end of the tool tooth flanks is clearly spaced from the tool top circle; at the tool tooth, a top area of the tool tooth is formed between the top-side end of the tool tooth flanks and the tool top circle and this narrows towards the tool top circle; a base-side end of the tool tooth flanks is clearly spaced from the tool base circle and a groove area, which narrows towards the tool base circle, is arranged between the base-side ends of tool tooth flanks of two tool teeth, which are located opposite one another, and the tool base circle.

### SUMMARY OF THE INVENTION

In accordance with an embodiment of the invention, a machine tool is provided, by means of which teeth of a high quality can be produced in a simple manner.

In accordance with an embodiment of the invention, a cold rolling device is provided for the production of rough teeth on at least one workpiece held by the workpiece holding device by way of cold rolling and a cutting machining device for the fine cutting machining of the rough teeth of the at least one workpiece, which is held in the workpiece holding device, is provided.

In accordance with an embodiment of the invention, a “cold rolling station” and “a cutting machining station” are formed on a machine tool. As a result, teeth of a high quality can be generated quickly and effectively. A cold rolling process is a reshaping process, with which material of the workpiece is displaced into cavities of the cold rolling tools. Rough teeth may be produced quickly by way of cold rolling. As a result of a subsequent cutting machining, a high tooth quality is obtained. The tooth quality may be improved, for example, by (at least) 20 μm to 30 μm. As a result, corresponding workpieces can, for example, be used as gear tooth workpieces.

When special cutting machining processes, such as shaping or shaving, are used, the machine tool may be designed in a simple manner since the corresponding machining methods have similar kinematics to cold rolling methods.

It is favorable when the workpiece holding device comprises at least one workpiece holder, on which a workpiece can be fixed so as to be rotatable about a workpiece axis. A rotation of the workpiece can then take place, driven via tools, during a cold rolling process and also during a cutting machining process.

It is favorable when the workpiece holding device has at least one displacement device, by means of which a workpiece is displaceable in a direction coaxial or parallel to a workpiece axis. As a result, it is possible to transfer a workpiece from the workpiece holding device to the cutting machining device by way of displacement.

Alternatively or in addition, it is possible for the workpiece holding device to have at least one pivoting device, by means of which an angular position of a workpiece can be adjusted for its fine cutting machining. When the workpiece is pivoted, it may be transferred from the cold rolling device to the cutting machining device when the tools are designed accordingly.

It is provided, in particular, for the angular position to be adjustable relative to an axis of movement of cold rolling tools. The axis of movement can, in this respect, be an axis of rotation when round tools are used or a linear axis when flat tools, which are moved in opposite directions, are used.

It is, in addition, favorable when the angular position can be adjusted relative to a cutting tool. As a result, the defined cutting machining can be carried out as a fine machining.

At least one combination of cold rolling tools with the first cold rolling tool and the second cold rolling tool is, in particular, provided, wherein the cold rolling tools are driven for synchronous movement. As a result of a corresponding, synchronized movement, a cold rolling process may be carried out with a workpiece between the cold rolling tools.

The tool holding device is designed, in particular, such that at least one workpiece can be positioned between the first cold rolling tool and the second cold rolling tool.

In one embodiment, the first cold rolling tool and the second cold rolling tool are flat tools and, in particular, cold rolling racks. In this respect, it is possible for the corresponding cold rolling racks to have a uniform profile or a varying profile adapted to the rough teeth to be produced.

The axis of movement for the movement back and forth of the first cold rolling tool and the second cold rolling tool is preferably at right angles to a workpiece axis in order to bring about a cold rolling reshaping.

It is also possible for the first cold rolling tool and the second cold rolling tool to be round tools.

It is provided, in particular, for an axis of rotation to be parallel to a workpiece axis.

It is favorable when a feeding device is provided, via which the first cold rolling tool and the second cold rolling tool can be advanced to the workpiece in a direction transverse to a workpiece axis. As a result, cold rolling racks with, for example, a uniform profile can be used. In this connection, reference is expressly made to WO 01/94048 A1.

It is particularly advantageous when at least one cutting tool for the fine cutting machining is provided. The at least one cutting tool can be, for example, a shaving tool or a shaping tool or a hob peeling tool or a hob cutting tool or a tooth honing tool. A fine machining of the rough teeth produced may then be carried out subsequent in time to the cold rolling process in the same clamping position.

In this respect, it is possible for the at least one cutting tool to be a flat tool or a round tool.

It is provided, in addition, for an operative surface of the at least one cutting tool to be oriented at an acute angle in relation to a workpiece axis. As a result, a corresponding cutting process may be carried out in order to be able to realize a fine machining of the rough teeth.

The angular position can be brought about by the positioning and/or the design of the at least one cutting tool and/or the positioning of the workpiece to be machined. In the latter case, the workpiece is, for example, pivoted following the cold rolling process.

It is particularly advantageous when a transfer device is provided, by means of which a workpiece can be transferred from a cold rolling tool to a cutting tool with engagement of the rough teeth. As a result, it is possible for the rough teeth produced not to become disengaged from the teeth of a tool. As a result, the orientation of the workpiece is not lost. As a result, the fine machining can be carried out quickly since no preparation time is necessary for refinding the orientation of the workpiece.

The transfer device has, in particular, corresponding teeth for the purpose of maintaining engagement. The transfer device can be considered as a tool which makes the transition between cold rolling and cutting possible.

The teeth of the transfer device are designed, in particular, such that they have such a large clearance and such a small tooth width that the workpiece can be transferred from the cold rolling tool to the at least one cutting tool without the workpiece becoming disengaged. The transition of the workpiece can be brought about by linear movement and/or pivoting.

The transfer device is arranged, in particular, between the cold rolling tool and the at least one cutting tool in order to make an effective and, therefore, time-saving transition possible.

In one embodiment, at least one tool is provided which has a cold rolling track as profiled track and a track for the cutting machining as cutting track. During a cold rolling process, the cold rolling track will be used and during the cutting machining the corresponding track will be used for the cutting machining. The transition may then be brought about in a simple manner.

A transfer track (of a transfer device) is arranged, in particular, between the cold rolling track and the cutting track in order to make an effective transfer of the workpiece possible without any disengagement needing to take place.

In this respect, it is possible for the cold rolling track and the cutting track to be arranged one behind the other with respect to a tool axis of movement. During the tool movement during the cold rolling, only the cold rolling track will be brought into operative engagement with the workpiece. After the cold rolling process has terminated, a displacement is brought about in such a manner that only the cutting track is brought into engagement during the cutting machining.

In this respect, it is possible for the cold rolling track and the cutting track to be arranged on a common rail and, in particular, form a combination tool. During the cold rolling, only a specific area of this rail will be brought into operative engagement with the workpiece. During the cutting machining, another area will be brought into operative engagement. The rail may be moved in a simple manner by one or more slides and, in particular, moved back and forth.

It may also be provided for the cold rolling track and the cutting track to be arranged next to one another and, in particular, parallel with respect to a tool axis of movement. During a cold rolling process, only the cold rolling track acts on the workpiece. So that the cutting track can act on the workpiece, the workpiece or the tool must be moved in the spacing direction of the cold rolling track and the cutting track.

In this respect, it is possible for the cold rolling track and the cutting track to be arranged on different rails. It is, in principle, also possible for them to be arranged on the same rail and form a combination tool.

In accordance with an embodiment of the invention, a method is provided, with which teeth of a high quality can be produced in an effective manner.

In accordance with an embodiment of the invention, rough teeth will be produced by way of cold rolling by means of a first cold rolling tool and a second cold rolling tool and the rough teeth will be finely machined by means of at least one cutting tool on the same machine tool in the same clamping position.

The method in accordance with the invention has the advantages already explained in conjunction with the machine tool in accordance with the invention.

Additional, advantageous developments of the method in accordance with the invention have likewise already been explained in conjunction with the machine tool in accordance with the invention.

During the cold rolling, the first cold rolling tool and the second cold rolling tool are moved synchronously. The synchronous movement can be a linear movement in opposite directions or a rotary movement in the same direction. The cold rolling tools are synchronized in this respect.

It is, in principle, possible for the cold rolling tools (when they are flat tools) to be designed with a varying profile which makes the production of the corresponding rough teeth possible. It is advantageous when the first cold rolling tool and the second cold rolling toll are advanced to the workpiece during the cold rolling in a direction transverse to a tool axis of movement and transverse to a workpiece axis. As a result, cold rolling racks may, for example, be used with the same profile over the length of the cold rolling racks in order to produce the rough teeth.

The workpiece is, in particular, clamped so as to be rotatable. It will then be driven in its rotary movement by the movement of the cold rolling tools which are in operative engagement with the workpiece.

In particular, the workpiece will be pivoted and/or displaced linearly with a workpiece axis following the cold rolling. As a result, it is possible to bring at least one cutting tool into engagement with the workpiece.

It is favorable when the workpiece is conveyed with its rough teeth to at least one cutting tool following the cold rolling. As a result it is possible for the orientation of the workpiece not to be lost.

In particular, the workpiece will be conveyed to the at least one cutting tool on transfer teeth, wherein the transfer teeth cause the workpiece to remain in engagement.

The fine machining is, for example, a shaping machining and/or shaving machining and/or hob peeling machining and/or hob cutting machining and/or tooth honing machining. As a result, teeth with a high quality may be produced which can be used, for example, as gear teeth.

The following description of preferred embodiments serves to explain the invention in greater detail in conjunction with the drawings.

### BRIEF DESCRIPTION OF THE DRAWINGS

FIG. 1 shows a schematic illustration of one embodiment of a machine tool in accordance with the invention;

FIG. 2(a) shows an enlarged illustration of a section of the machine tool according to FIG. 1 during a cold rolling process;

FIG. 2(b) shows a sectional view along line b-b according to FIG. 2(a);

FIG. 2(c) shows a front view of the area according to FIG. 2(a);

FIG. 3(a) shows the same view as FIG. 2(a) but during cutting machining;

FIG. 3(b) shows a sectional view along line b-b according to FIG. 3(a);

FIG. 4(a) shows a partial view similar to FIG. 2(a) in a further embodiment of a machine tool in accordance with the invention during a cold rolling process;

FIG. 4(b) shows a sectional view along line b-b according to FIG. 4(a);

FIG. 4(c) shows a front view of the area according to FIG. 4(a);

FIG. 5(a) shows the same view as in FIG. 4(a) during cutting machining;

FIG. 5(b) shows a sectional view along line b-b according to FIG. 5(a);

FIG. 6(a) shows an enlarged view of a section of a further embodiment of a machine tool in accordance with the invention during a cold rolling process;

FIG. 6(b) shows a sectional view along line b-b according to FIG. 6(a);

FIG. 6(c) shows a front view of the area according to FIG. 6(a);

FIG. 7(a) shows the same view as in FIG. 6(a) during a cutting machining process;

FIG. 7(b) shows a sectional view along line b-b according to FIG. 7(a); and

FIG. 8 shows a partial illustration of a further embodiment of a machine tool in accordance with the invention.

### DETAILED DESCRIPTION OF THE INVENTION

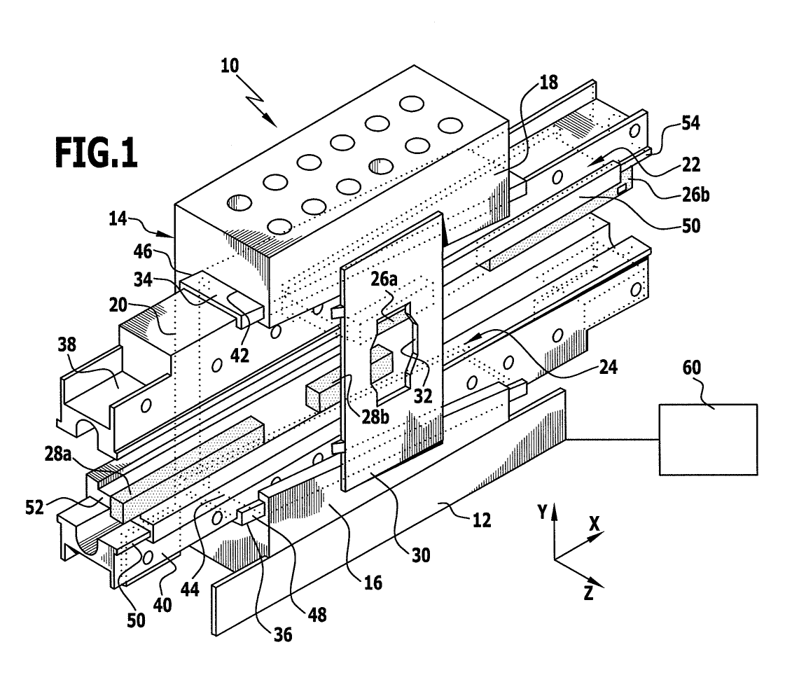

One embodiment of a machine tool in accordance with the invention, which is shown in FIG. 1 and designated as a whole as 10, comprises a machine base frame 12, via which the machine tool 10 stands on a base. A C-shaped frame 14 is connected to the machine base frame 12.

This frame 14 has a first holding area 16 and a second holding area 18 located opposite. The two holding areas 16 and 18 are connected to one another via a connecting area 20. The first holding area 16 projects in a transverse direction z beyond the connecting area 20. The second holding area 18 likewise projects in the transverse direction z beyond the connecting area 20. The first holding area 16 and the second holding area 18 each form, as a result, holding jaws, at which a first tool holder 22 (at the first holding area 16) and a second tool holder 24 (at the second holding area 18), respectively, are held so as to be movable. The two tool holders 22, 24 are located opposite one another. One or more tools may be fixed to each of them.

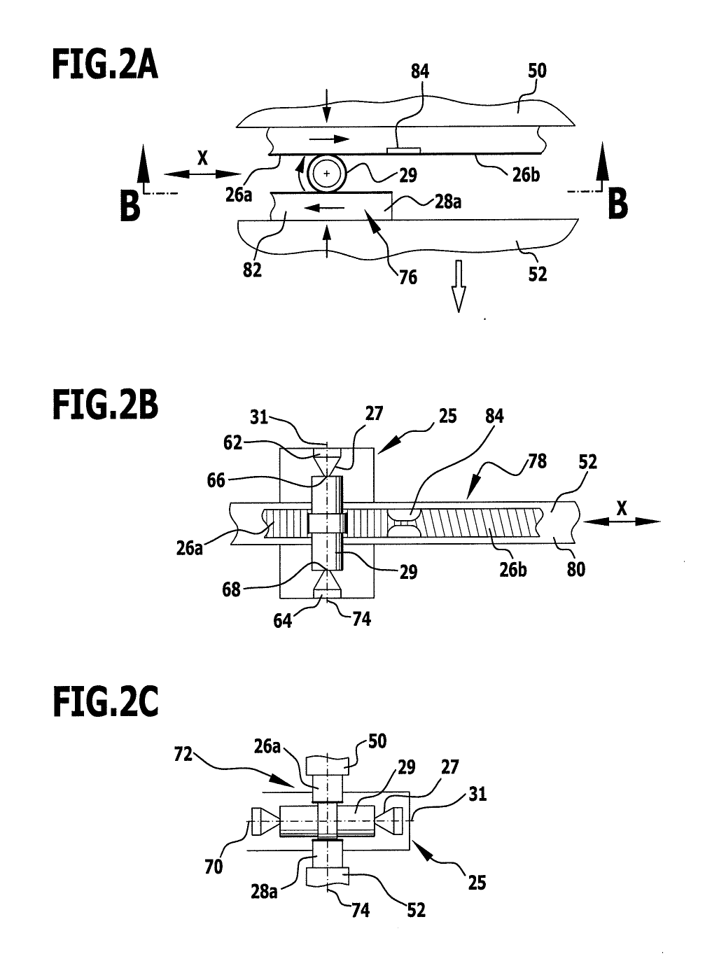

A workpiece holding device 25 with one or a plurality of workpiece holders 27, which are fixed to the connecting area 20 at least on one side (FIG. 2), is arranged between the tool holders 22 and 24. A workpiece 29 can be inserted into each workpiece holder 27, wherein it is held on the machine tool 10 by the workpiece holder so as to be rotatable about a workpiece axis 31 so that a cold rolling process for the production of rough teeth on the workpiece 29 and a fine cutting machining of the rough teeth can be carried out.

A reinforcing bracket 30 is arranged between the first holding area 16 and the second holding area 18 opposite the connecting area 20. This bracket has an opening 32 in the area of the workpiece holders, through which tailstock parts of a workpiece holder 27 can, in particular, pass.

In the embodiment shown, the tool holders 22 and 24 are each movable in a longitudinal direction x and in the transverse direction y to the longitudinal direction x.

The first holding area 16 and the second holding area 18 each have an inclined guide path 34 and 36, respectively, on which a first wedge slide 38 and a second wedge slide 40, respectively, are guided. The guide path 34 is inclined at an acute angle in relation to the direction x. The guide path 36 of the second holding area 18 is parallel to the guide path 34 of the first holding area 16.

The distance between the tool holders 22, 24 in the direction y may be adjusted depending on the position of the wedge slides 38, 40 on their guide paths 34, 36.

Recesses 42, 44, in which guide rails 46, 48 of the respective wedge slides 38, 40 are accommodated, are formed, for example, in the holding areas 16 and 18 for guiding the wedge slides 38, 40.

Tools 26a, 26b and 28a, 28b may be advanced to a workpiece in the direction y via the guidance of the wedge slides 38, 40. In particular, the tools 26a, 26b and 28a, 28b may be displaced in a radial direction with respect to the workpiece during a rolling process and during any fine cutting machining.

The movement of the wedge slides 38, 40 on their guide paths 34 and 36, respectively, is driven. For this purpose, a corresponding drive is provided (not shown in the drawings). With respect to the design of the drive, reference is made to WO 01/94048 A1 and US 2004/0007034 A1.

A first tool slide 50 is guided on the first wedge slide 38 for linear displacement in the direction x. Furthermore, a second tool slide 52 is guided on the second wedge slide 40 for linear displacement in the direction x, wherein the directions of guidance of the two tool slides 50, 52 are aligned parallel. The tools 26a, 26b and 28a, 28b are seated directly on the tool slides 50, 52, respectively, (FIG. 2), i.e. are fixed on them so as to be immovable.

For the purpose of guiding the tool slides 50, 52, the wedge slides 38, 40 have guide paths 54, 56 which face one another. The tool slides 50, 52 are seated on these respective slides, wherein their movement in the x direction is driven. The corresponding drives are not shown in the drawings. In this connection, reference is made to WO 01/94048 A1 and US 2004/0007034 A1.

During the machining of a workpiece, the tool slides 50 and 52, which are spaced in the y direction, are driven synchronously in opposite directions; during the movement of the tool slide 50 in the +x direction, the other tool slide 52 moves in the −x direction and vice versa.

The tools 26a, 26b, 28a, 28b may be moved in the x direction and y direction via the tool holders 22, 24. The movement in the y direction may also be carried out, in particular, during a machining process. For their movement in the x direction, the tool slides 50 and 52 are driven for movement on their respective guide paths 54, 56. For their movement in the y direction, the wedge slides 38, 40 are driven for displacement on their respective guide paths 34, 36.

A tool slide 50, 52 can hold one tool or a plurality of tools. When a plurality of tools is held, different profile machining processes can be carried out on a workpiece one after the other. In particular, different types of profile may be introduced when the tools are designed accordingly or a profile may be roughly machined (by way of cold rolling) and finely machined (by way of cutting machining) without any external change of tool and any reclamping of a workpiece needing to be carried out.

The tool slide 52 (and, accordingly, the tool slide 50) has a fixing device for one or more tools. The tool or tools can be securely positioned in an x position, y position and z position on the tool slide 52 via the fixing device. For example, several tools can be positioned one behind the other in the x direction. A transverse offset in the z direction is also possible or a vertical offset in the y direction is possible. This results in extensive possibilities for the production of profiles on a workpiece.

The machine tool 10 has a control device 60 (shown schematically in FIG. 1). This control device 60 is arranged, for example, in a switch box. The machine tool 10 may be controlled via the control device 60. The movement of the tool holders 22 and 24 in the direction x and the advancing in the direction y may be controlled, in particular. Furthermore, the position of the tool slides 50 and 52 with respect to the selection of the tools (26a and 28a or 26b and/or 28b) can be controlled.

Each workpiece holder 27 comprises a first contact element 62 and a second contact element 64 with respective contact tips 66, 68, between which a workpiece 28 can be clamped. A clamped workpiece 29 is rotatable about the axis 70 of the corresponding workpiece holder 27. The axis 27 of the corresponding workpiece holder 64 is located between the tips 66 and 68. The axis of rotation 31 of a workpiece 29, which is clamped in the corresponding workpiece holder 27, is a workpiece axis and coincides with this axis 70.

A workpiece holder 27 has, for example, a stationary headstock part, on which the first contact element 62 is arranged or formed. Furthermore, a workpiece holder 27 has a tailstock part, on which the second contact element 64 is formed or is arranged. The tailstock part is movable in a direction which is aligned, in particular, parallel to the axis 70. A workpiece 29 may be tensioned in the associated workpiece holder 27 via the tailstock part. The workpiece holder 27 can be displaced and/or be pivotable as a whole, as will be explained below.

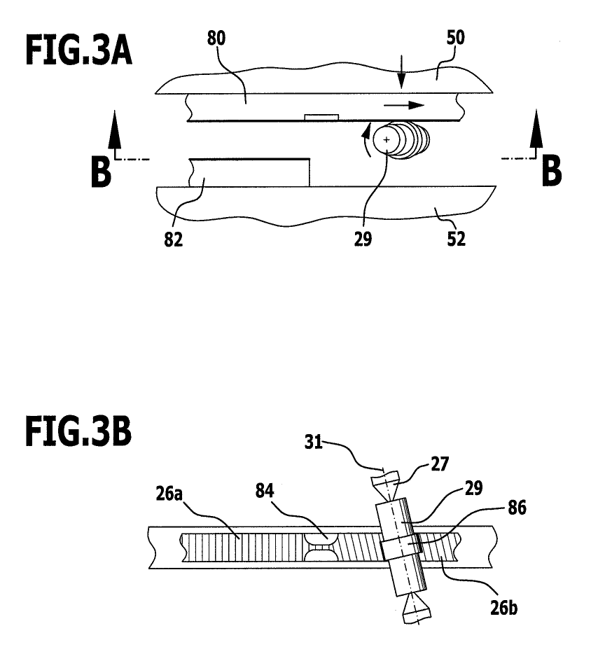

In one embodiment (FIGS. 2 and 3), the workpiece holding device 25 comprises a pivoting device 72, via which the workpiece holder 27 can be pivoted about a pivot axis 74 and, as a result, an angular position of the axis 70 and, therefore, of the workpiece axis can be adjusted relative to the x direction.

The machine tool 10 comprises a cold rolling device 76, via which rough teeth can be produced on a workpiece 29 by way of cold rolling. Furthermore, it comprises a cutting machining device 78, via which a fine machining of the rough teeth by way of a cutting method may be carried out following production of the rough teeth.

For the formation of the cold rolling device 76, a combination tool 80, which comprises the tools 26a and 26b, is arranged on the first tool slide 50. A tool 82, which comprises the tools 28a and 28b, is arranged on the second tool slide 52. The tool 26a of the combination tool 80 is a cold rolling tool, in particular in the form of a cold rolling jaw with a profile which is predetermined by the rough teeth to be produced. The tool 26b of the combination tool 80 is a cutting tool, such as, for example, a shaping tool or a shaving tool. The tool 26a forms a first cold rolling tool.

The tools 26a and 26b are arranged on the same rail of the combination tool 80, wherein they are arranged one behind the other in the x direction and spaced from one another.

A transfer device 84 is arranged between the cold rolling tool 26a and the cutting tool 26b. This is designed as transfer teeth which allow a transfer of the workpiece 29 from the first cold rolling tool 26a to the cutting tool 26b without the workpiece 29 becoming disengaged, i.e., the rough teeth on the workpiece 29, which have been produced via the cold rolling tools 26a and 28a, remain in engagement with the transfer teeth 84 during the transfer to the teeth of the cutting tool 26b.

The teeth of the transfer unit 84 have, with respect to the (rough) teeth of the workpiece 29 which are produced by way of cold rolling, such a large clearance and such a small tooth width that the transfer is made possible.

The tool 28a is a second cold rolling tool. The tools 26a and 28a thereby form a combination of cold rolling tools, between which the workpiece 29 is positioned.

It is, in principle, sufficient for only one of the combination tools 80 or 84 to have a cutting tool (26b or 28b).

The corresponding workpiece blank is clamped on the workpiece holder 27 for the production of the rough teeth on the workpiece 29. The axis of rotation 31 and the workpiece axis 70 are thereby aligned in z direction transversely and, in particular, at right angles to the x direction.

The cold rolling tools 26a and 28a move synchronously in opposite directions in the x direction during a cold rolling process, wherein they are advanced to the workpiece 29 in the y direction. The cutting tool 26b and 28b, respectively, does not come into contact with the workpiece 29 during the cold rolling process.

The cold rolling process is illustrated schematically in FIGS. 2(a), (b) and (c).

During the cold rolling, the cold rolling tools 26a and 28a are moved synchronously in opposite directions via their respective tool slides 50 and 52. The cold rolling tools 26a and 28a are profiled. The tools 26a and 28a impact on the workpiece 29 at the same time. The workpiece is caused to rotate about the axis 31, first of all by way of friction and then by way of form locking. Material is displaced into cavities of the profiled tools 26a, 28a. The cold rolling is a tension-less reshaping technique. Teeth may be produced with cold rolling very much more quickly than by way of cutting machining.

In one embodiment with feeding in the y direction, the tools 26a and 28a may be designed with a profile depth which remains the same. In this respect, reference is made to WO 01/94048 A1 and WO 2006/045566 A1.

Once the cold rolling process has finished, the workpiece 29, which now has rough teeth 86, will, as shown schematically in FIG. 3, be transferred to the tool 26b (cutting tool). This is brought about by a displacement of the combination tool 80. In addition, the combination tool 82 is displaced such that it is no longer in engagement with the workpiece 29. During the displacement of the workpiece 29 in the transfer area 84, the workpiece 29 will be brought into a pivoted position via the pivoting device 72, i.e., the axis 31 and, therefore, also the workpiece axis 70 will be brought into a finite angle (angle not equal to 0° and not equal to 90°) in relation to the x direction. This finite angle is, in particular, an acute angle.

For the fine machining of the rough teeth 86, the cutting tool 26b is conveyed to the workpiece 29, wherein feeding takes place in the y direction.

The cutting tool 26b carries out fine machining on the rough teeth. A rolling movement and a transverse movement take place. The cutting edges of the tool 26b are at an angle to the workpiece 29.

During the fine machining, the quality of the teeth will be improved. It has been shown, for example, that the tooth quality for gear teeth is too low by approximately 20 μm to 30 μm as a result of the cold rolling. As a result of the cutting machining with the tool 26b, a quality of the teeth is achieved which is, for example, adequate for gear teeth.

The cutting tool 26b is designed, for example, as a shaping tool or shaving tool.

The cold rolling process and the cutting machining have, in principle, similar kinematics. As a result, the cold rolling via the cold rolling device 76 for the production of the rough teeth 86 and the subsequent fine cutting machining by the cutting machining device 78 may be carried out on the same machine tool 10 without the clamping (chucking) position of the workpiece 29 needing to be altered. The slides 50 and 52 are moved synchronously back and forth during the cold rolling. During the cutting machining, the slide 50 which holds the cutting tool 26b will be moved back and forth. Both times, a y feeding to the workpiece takes place.

A transfer from the cold rolling tools 26a, 28a to the cutting tool 26b may be carried out via the transfer device 84, wherein pivoting is made possible; the rough teeth 86 produced will not be disengaged from the combination tool 80 and so the orientation of the workpiece will not be lost.

When the end of the tool 26a is reached during the displacement of the combination tool 80 once the cold rolling process has finished, a pivoting procedure of the workpiece 29 can be initiated which must be terminated before the beginning of the cutting tool 26b is reached. During the movement over the transfer teeth of the transfer device 84, the necessary movement between feeding movement of the combination tool 80 in x direction and pivoting movement of the workpiece 29 by the pivoting device 72 need be realized only relatively inexactly.

During the cold rolling process, the tool slides 50 and 52 are moved only in such a manner that the cold rolling tools 26a and 28a are in constant operative connection with the workpiece 29. During the fine cutting machining, the combination tool 80 (once the combination tool 82 has moved away) will be moved only to such an extent that only the cutting tool 26b acts on the workpiece 29.

As mentioned above, it is possible for only one of the combination tools 80 and 82 to have a cutting tool. A uniform wear and tear may be achieved when both the combination tools 80 and 82 each have a cutting tool and these are used alternatingly (for different workpieces) for the purpose of uniform tool wear.

In x direction, the combination tool has tracks which are located one behind the other, namely the profiled track of the cold rolling tool 26a and the cutting track of the cutting tool 26b which are connected by the transfer device 84.

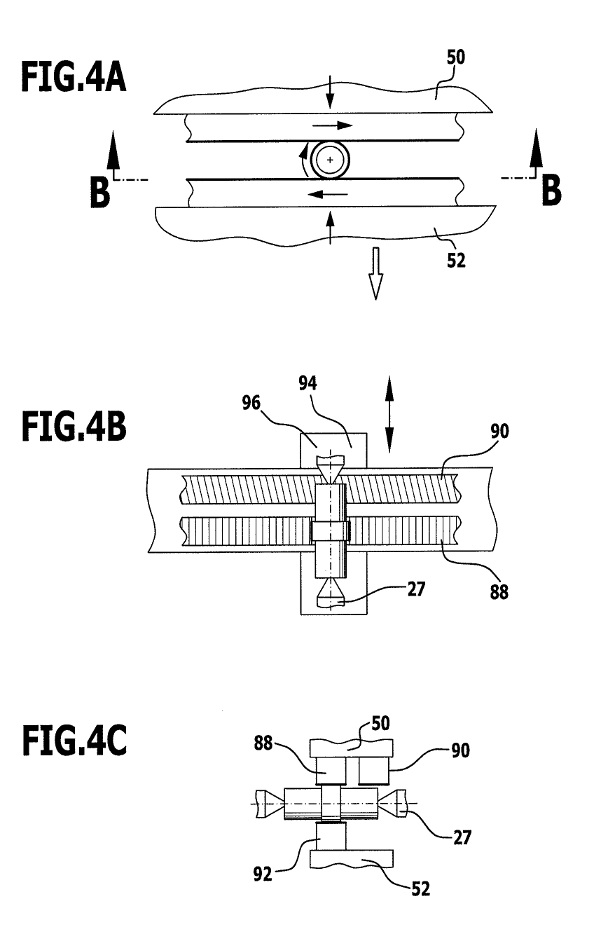

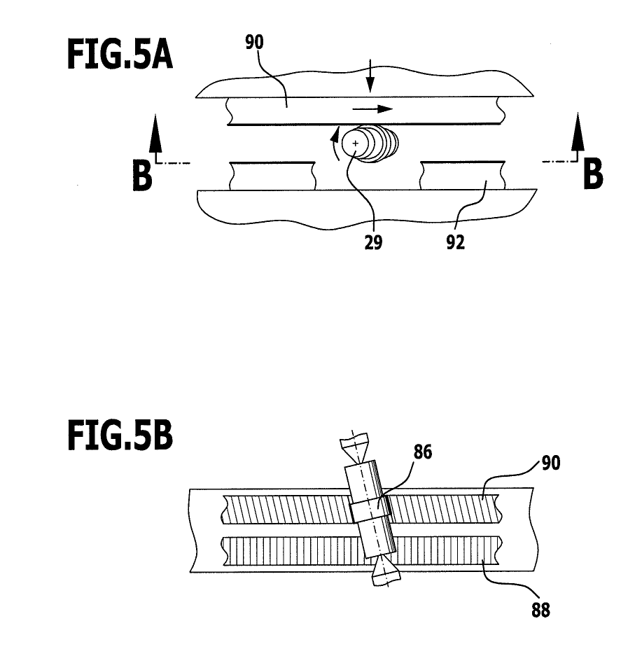

In a further embodiment, which is shown schematically in FIGS. 4 and 5, a first cold rolling tool 88 is held on the first tool slide 50. Furthermore, a cutting tool 90 is held on the first tool slide 50 parallel to the first cold rolling tool 88. The first cold rolling tool 88 has a profiled track which is located parallel to a cutting track of the cutting tool 90. The first cold rolling tool 88 and the cutting tool 90 are formed on separate rails. It is, in principle, also possible for them to be formed on the same rail and, in particular, to be arranged on a combination tool.

A second cold rolling tool 92 is held on the second tool slide 52. A workpiece holding device 94, on which the workpiece holder 27 is arranged (which is, in principle, of the same design as described above), has a displacing device 96, by means of which a workpiece is displaceable coaxially or parallel to the axis 70 of the workpiece holder 27 and, in particular, is displaceable in the z direction.

In addition, a pivoting device corresponding to the pivoting device 72 is provided for adjusting the pivoted position of the workpiece axis 70 with respect to the x direction.

As a result, the workpiece with the rough tooth area 86 produced can, as shown schematically in FIG. 5(b), be displaced towards the cutting tool 90 once a cold rolling process has been carried out. The cold rolling tools 88 and 92 are, in this respect, caused to disengage.

A transfer device may be provided between the first cold rolling tool 88 and the cutting tool 90 in order to make a transfer possible without the teeth being caused to disengage.

Otherwise, the production of the teeth takes place as described above, i.e., a cold rolling process for the production of the rough teeth 86 is carried out first of all via the cold rolling tools 88 and 92. Then, the rough tooth area is brought into operative engagement with the cutting tool 90 which carries out the fine machining of the rough teeth. The cutting tool 90, on the other hand, is, for example, a shaping tool or a shaving tool or a hob peeling tool or hob cutting tool or tooth honing tool.

In the embodiments according to FIGS. 2 to 5, the tools are flat tools (flat jaw tools) and, in particular, cold rolling racks and cutting racks (such as shaving racks).

It is, in principle, also possible for a cold rolling rack to be used as first cold rolling tool 98 for the method for cold rolling in accordance with the invention and a cold rolling rack likewise as second cold rolling tool 100. A round tool is used as cutting tool 102 which can be turned and, in particular, rotated about an axis 104. In this respect, the axis 104 is arranged, in particular, at an angle (and, in particular, at an acute angle) in relation to the axis 70 of the workpiece holder 27.

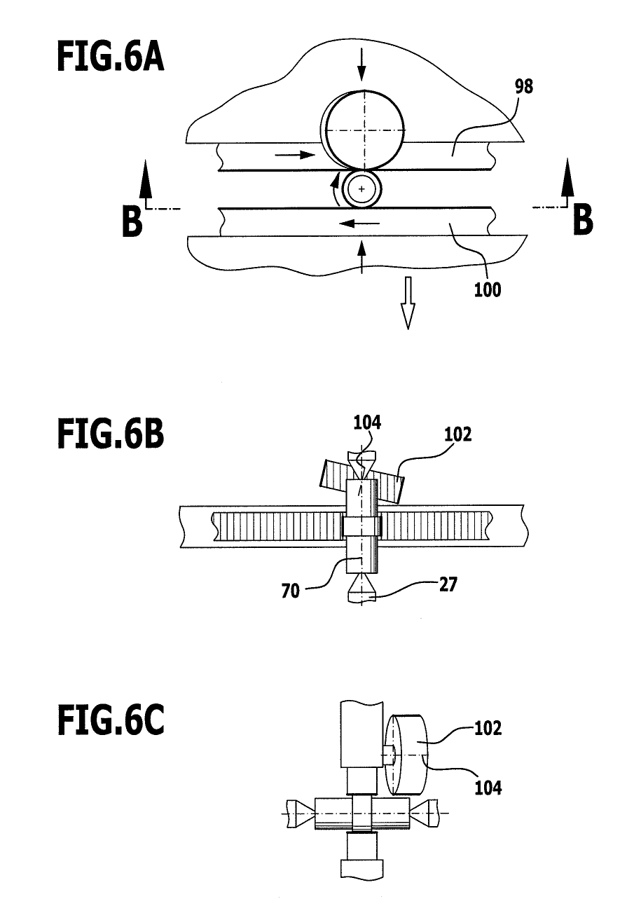

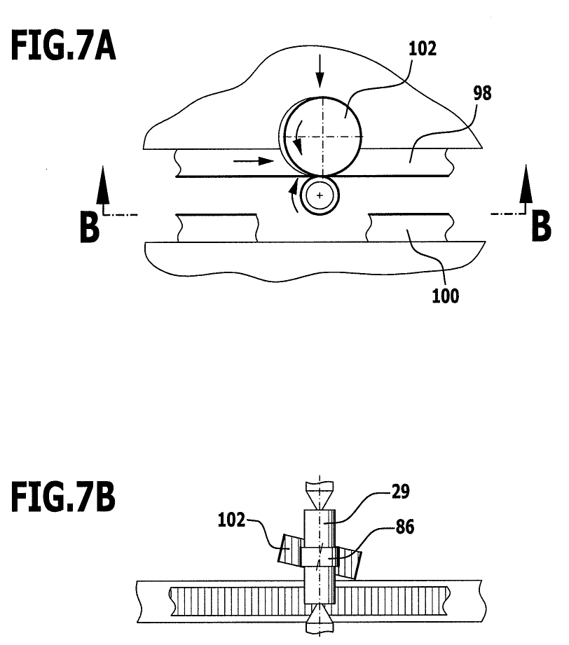

First of all, a cold rolling process takes place by means of the cold rolling racks 98 and 100 (FIG. 6). Subsequently, the rough teeth produced are brought into operative engagement with the cutting tool 104 by way of displacement in the z direction. This then carries out a fine cutting machining of the rough teeth, for example, by way of shaping or shaving.

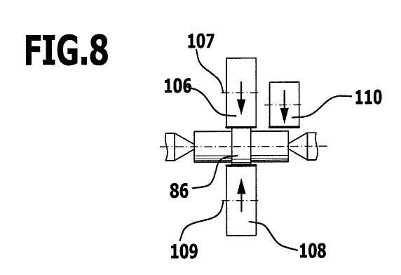

It is, for example, also possible, as indicated in FIG. 8, for a round tool (cold rolling roller) to be used as first cold rolling tool 106 and a round tool (cold rolling roller) to likewise be used as second cold rolling tool 108 which are rotatable about axes of rotation 107 and 109, respectively.

During a cold rolling process, these will be advanced for the production of the rough teeth 86.

Following the cold rolling process, the rough tooth area 86 will, as described above, be brought into operative engagement with a cutting tool 110. The cutting tool 110 can be a flat tool or a round tool.

With the method in accordance with the invention, a “conventional” cold rolling process will be carried out first of all with cold rolling tools which are located opposite one another, are moved synchronously and driven in opposite directions (in the case of flat tools) or in the same direction (in the case of round tools). The cold rolling tools can be flat tools which are moved linearly in opposite directions or round tools which are rotated in the same direction. The cold rolling process is a tension-less reshaping process.

With the same clamping position of the workpiece which now has rough teeth, a transfer to a cutting tool, such as, for example, a shaving tool or shaping tool, will be carried out in the same machine tool. For this purpose, the workpiece will, for example, be transported linearly and/or pivoted through a transfer unit with transfer teeth. The cold rolling tools are thereby brought out of operative engagement with the workpiece. Once the cutting tool is reached, a cutting machining takes place, by means of which the quality of the teeth is improved. The cutting machining takes place by way of linear movement (in particular, movement back and forth) of the cutting tool or by way of a rotary movement with y feeding each time. A quality of the teeth which is suitable, for example, for gear teeth will be obtained, for example, by way of shaping and/or shaving and/or hob peeling and/or hob cutting and/or tooth honing.

With the solution in accordance with the invention, flat tools or round tools may be used for the cold rolling. A corresponding flat tool or round tool may be used for the fine cutting machining.

The cold rolling and the cutting machining are carried out one after the other with respect to time. An alteration in the angular position is not necessary for the cutting machining. This can be brought about by altering the angular position of the workpiece and/or by corresponding adjustment of the angular position of the cutting tool.

1. Machine tool for the production of teeth on workpieces, comprising:
a workpiece holding device;
a cold rolling device for the production of rough teeth on at least one workpiece held by the workpiece holding device by way of cold rolling; and
a cutting machining device for the fine cutting machining of the rough teeth of the at least one workpiece held on the workpiece holding device.

2. Machine tool as defined in claim 1, wherein the workpiece holding device comprises at least one workpiece holder, a workpiece being fixable on said holder so as to be rotatable about a workpiece axis.

3. Machine tool as defined in claim 1, wherein the workpiece holding device has at least one displacement device, a workpiece being displaceable by said device in a direction coaxial or parallel to a workpiece axis.

4. Machine tool as defined in claim 1, wherein the workpiece holding device has at least one pivoting device, an angular position of a workpiece being adjustable for its fine cutting machining by means of said device.

5. Machine tool as defined in claim 4, wherein the angular position is adjustable relative to an axis of movement of cold rolling tools.

6. Machine tool as defined in claim 4, wherein the angular position is adjustable relative to a cutting tool.

7. Machine tool as defined in claim 1, comprising at least one combination of cold rolling tools with a first cold rolling tool and a second cold rolling tool driven for synchronous movement.

8. Machine tool as defined in claim 7, wherein the workpiece holding device is designed such that at least one workpiece is positionable between the first cold rolling tool and the second cold rolling tool.

9. Machine tool as defined in claim 7, wherein the first cold rolling tool and the second cold rolling tool are flat tools.

10. Machine tool as defined in claim 9, wherein an axis of movement of the first cold rolling tool and of the second cold rolling tool is at right angles to a workpiece axis.

11. Machine tool as defined in claim 7, wherein the first cold rolling tool and the second cold rolling tool are round tools.

12. Machine tool as defined in claim 11, wherein an axis of rotation is parallel to a workpiece axis.

13. Machine tool as defined in claim 7, comprising a feeding device for advancing the first cold rolling tool and the second cold rolling tool to the workpiece in a direction transverse to a workpiece axis.

14. Machine tool as defined in claim 1, comprising at least one cutting tool for the fine cutting machining.

15. Machine tool as defined in claim 14, wherein the at least one cutting tool is a flat tool.

16. Machine tool as defined in claim 14, wherein the at least one cutting tool is a round tool.

17. Machine tool as defined in claim 14, wherein the at least one cutting tool is a shaping tool or shaving tool or hob peeling tool or hob cutting tool or tooth honing tool.

18. Machine tool as defined in claim 14, wherein an operative surface of the at least one cutting tool is oriented at an acute angle in relation to a workpiece axis.

19. Machine tool as defined in claim 18, wherein the angular adjustment is brought about by at least one of the positioning, the design of the at least one cutting tool, and the positioning of the workpiece to be machined.

20. Machine tool as defined in claim 1, comprising a transfer device for transferring a workpiece from a cold rolling tool to a cutting tool with engagement of the rough teeth.

21. Machine tool as defined in claim 20, wherein the transfer device has teeth.

22. Machine tool as defined in claim 21, wherein the teeth of the transfer device for the workpiece have such a large clearance and have such a small tooth width that the workpiece is transferable from the cold rolling tool to the at least one cutting tool without the workpiece becoming disengaged.

23. Machine tool as defined in claim 20, wherein the transfer device is arranged between the cold rolling tool and the at least one cutting tool.

24. Machine tool as defined in claim 1, comprising at least one tool having a cold rolling track and a track for the cutting machining.

25. Machine tool as defined in claim 24, wherein a transfer track is arranged between the cold rolling track and the cutting track.

26. Machine tool as defined in claim 24, wherein the cold rolling track and the cutting track are arranged one behind the other with respect to a tool axis of movement.

27. Machine tool as defined in claim 26, wherein the cold rolling track and the cutting track are arranged on a common rail.

28. Machine tool as defined in claim 24, wherein the cold rolling track and the cutting track are arranged next to one another with respect to a tool axis of movement.

29. Machine tool as defined in claim 28, wherein the cold rolling track and the cutting track are arranged on different rails.

30. Method for the production of teeth on a workpiece by means of a machine tool, comprising:
clamping a workpiece on a workpiece holder;
producing rough teeth by way of cold rolling by means of a first cold rolling tool and a second cold rolling tool; and
fine machining the rough teeth by means of at least one cutting tool on the same machine tool in the same clamping position.

31. Method as defined in claim 30, wherein the first cold rolling tool and the second cold rolling tool are moved synchronously during the cold rolling.

32. Method as defined in claim 31, wherein the first cold rolling tool and the second cold rolling tool are advanced to the workpiece during the cold rolling in a direction transverse to a tool axis of movement and transverse to a workpiece axis.

33. Method as defined in claim 30, wherein the workpiece is clamped so as to be rotatable.

34. Method as defined in claim 30, wherein after the cold rolling the workpiece is at least one of pivoted and displaced linearly with a workpiece axis.

35. Method as defined in claim 30, wherein after the cold rolling the workpiece is conveyed with its rough teeth to at least one cutting tool.

36. Method as defined in claim 35, wherein the workpiece is conveyed to the at least one cutting tool on transfer teeth, wherein the transfer teeth cause the workpiece to remain in engagement.

37. Method as defined in claim 30, wherein the fine machining is at least one of a shaping machining, shaving machining, hob peeling machining, hob cutting machining and tooth honing machining.
